(19) United States
(12) Patent Application Publication
(10) Pub. No.: US 2026/0321508 A1
(43) Pub. Date: Oct. 15, 2026

(54) ELECTRONIC COMPONENT

(71) Applicant: Murata Manufacturing Co., Ltd., Nagaokakyo-shi (JP)

(72) Inventors: Yuri HIYOSHI, Nagaokakyo-shi (JP); Hiroyuki AOYAMA, Nagaokakyo-shi (JP); Junya TANAKA, Nagaokakyo-shi (JP)

(73) Assignee: Murata Manufacturing Co., Ltd., Nagaokakyo-shi (JP)

(21) Appl. No.: 19/467,863

(22) Filed: Feb. 3, 2026

(30) Foreign Application Priority Data
Feb. 5, 2025 (JP) 2025-017535

(51) Int. Cl. H01G 4/30; H01G 4/232

(52) U.S. Cl. CPC H01G 4/30; H01G 4/232

(57) ABSTRACT

An electronic component includes an element body and outer electrodes. A first outer electrode includes a first-end portion on a first surface of the element body having a protruding portion that extends in a length direction. A first apex of the protruding portion is offset from a first imaginary plane bisecting the element body in a first direction and is positioned closer to a third side surface than to a second imaginary plane bisecting the element body in a second direction. An edge of a side surface portion of the first outer electrode includes a curved portion projecting toward the center of the element body in the length direction. A portion of the curved portion projecting farthest toward the center of the element body in the length direction is positioned closer to the third side surface than to the second imaginary plane.

### CROSS-REFERENCE TO RELATED APPLICATION

This application claims priority to Japanese Patent Application No. 2025-017535, filed on Feb. 5, 2025, the entire contents of which are incorporated herein by reference.

### BACKGROUND

### 1. Field

The present disclosure relates to an electronic component.

### 2. Description of the Related Art

To date, an electronic component including an element body, which has a substantially rectangular-parallelepiped shape and in which dielectric layers and inner electrode layers are alternately stacked, and an outer electrode, which is provided on each of a pair of end surfaces in the length direction of the element body, is known. The outer electrode not only covers the end surface of the element body but also extends from the end surface to each of four side surfaces of the element body. The electronic component is mounted on a substrate by using solder joined to the outer electrode.

When an alternative current voltage is applied to the electronic component mounted on the substrate, the element body may vibrate finely due to electrostriction and so-called “acoustic noise” may be generated as the vibration is transmitted to the substrate.

Japanese Unexamined Patent Application Publication No. 2014-132633, for example, is a related art document that discloses a configuration of an electronic component with reduced such acoustic noise. The electronic component disclosed in Japanese Unexamined Patent Application Publication No. 2014-132633 includes a first outer layer and a second outer layer that are positioned on an outer side portion of an inner layer portion including dielectric layers and inner electrode layers that are alternately stacked. The thickness of one of the first outer layer and the second outer layer is greater than the thickness of the other of the first outer layer and the second outer layer.

### SUMMARY

An electronic component according to the present disclosure includes an element body, a first outer electrode, and a second outer electrode. The element body has a first end surface and a second end surface that face each other in a length direction, a first side surface and a second side surface that face each other in a first direction perpendicular to the length direction, and a third side surface and a fourth side surface that face each other in a second direction perpendicular to the length direction and the first direction. The element body includes a plurality of dielectric layers and a plurality of inner electrode layers that are stacked in the first direction or the second direction. The first outer electrode is provided on the first end surface and on a part of each of the first side surface, the second side surface, the third side surface, and the fourth side surface. The second outer electrode is provided on the second end surface and on a part of each of the first side surface, the second side surface, the third side surface, and the fourth side surface. The element body includes a first-end ridgeline portion that is a portion where the first end surface intersects each of the first side surface, the second side surface, the third side surface, and the fourth side surface, and a second-end ridgeline portion that is a portion where the second end surface intersects each of the first side surface, the second side surface, the third side surface, and the fourth side surface. The first outer electrode at least includes a first-end first outer electrode and a first-side first outer electrode. The first-end first outer electrode is positioned on the first end surface. The first-side first outer electrode is connected to the first-end first outer electrode and positioned on a part of the first side surface. The first-end first outer electrode includes a first-end protruding portion that protrudes in a direction away from the first end surface in the length direction. A first imaginary plane is defined as an imaginary plane that bisects the element body in the first direction and a second imaginary plane is defined as an imaginary plane that bisects the element body in the second direction. In this case, a first apex portion of the first-end protruding portion that protrudes farthest in the length direction does not overlap the first imaginary plane and the first-end ridgeline portion when seen in the length direction and is positioned closer than the second imaginary plane to the third side surface. An edge portion of the first-side first outer electrode that is positioned near a center of the element body in the length direction includes a first curved portion that projects toward the center of the element body in the length direction. A portion of the first curved portion that projects farthest toward the center of the element body in the length direction is positioned closer than the second imaginary plane to the third side surface. The second outer electrode at least includes a second-end second outer electrode and a first-side second outer electrode. The second-end second outer electrode is positioned on the second end surface. The first-side second outer electrode is connected to the second-end second outer electrode and positioned on a part of the first side surface. The second-end second outer electrode includes a second-end protruding portion that protrudes in a direction away from the second end surface in the length direction. A second apex portion of the second-end protruding portion that protrudes farthest in the length direction does not overlap the first imaginary plane and the second-end ridgeline portion when seen in the length direction and is positioned closer than the second imaginary plane to the third side surface. An edge portion of the first-side second outer electrode that is positioned near the center of the element body in the length direction includes a second curved portion that projects toward the center of the element body in the length direction. A portion of the second curved portion that projects farthest toward the center of the element body in the length direction is positioned closer than the second imaginary plane to the third side surface.

With the present disclosure, an electronic component with reduced acoustic noise while ensuring high production efficiency may be realized.

### BRIEF DESCRIPTION OF THE DRAWINGS

FIG. 1 is a schematic external perspective view of a multilayer ceramic capacitor according to an embodiment;

FIG. 2 is a schematic sectional view taken along line II-II in FIG. 1;

FIG. 3 is a schematic sectional view taken along line III-III in FIG. 1;

FIG. 4 is a schematic sectional view taken along line IV-IV in FIG. 2;

FIG. 5 is a schematic sectional view taken along line V-V in FIG. 2;

FIG. 6 is a schematic view as seen in the direction of arrow VI in FIG. 1;

FIG. 7 is a schematic view as seen in the direction of arrow VII in FIG. 1;

FIG. 8 is a schematic view as seen in the direction of arrow VIII in FIG. 1;

FIG. 9 is a schematic view as seen in the direction of arrow IX in FIG. 1;

FIG. 10 is a flowchart illustrating a method of manufacturing a multilayer ceramic capacitor according to an embodiment;

FIG. 11 is a schematic view for illustrating step S81 of the manufacturing flow illustrated in FIG. 10;

FIG. 12 is a schematic view for illustrating step S81 of the manufacturing flow illustrated in FIG. 10;

FIG. 13 is a schematic view for illustrating step S82 of the manufacturing flow illustrated in FIG. 10;

FIG. 14 is a schematic view for illustrating a movement direction of an element body illustrated in FIG. 13;

FIG. 15 is a schematic view for illustrating step S82 of the manufacturing flow illustrated in FIG. 10;

FIG. 16 is a schematic view illustrating a state in which the multilayer ceramic capacitor illustrated in FIG. 1 is mounted on a substrate;

FIG. 17 is a schematic view of a multilayer ceramic capacitor according to a first modification; and

FIG. 18 is a schematic view of a multilayer ceramic capacitor according to a second modification.

### DESCRIPTION OF THE EMBODIMENTS

Hereafter, embodiments of the present disclosure will be described in detail with reference to the drawings. In the following description of the embodiments, the same or common portions will be denoted by the same numerals in the figures and descriptions thereof will not be repeated. In the following descriptions of the embodiments according to the present disclosure, a multilayer ceramic capacitor will be used as an example of an electronic component.

In the figures, L denotes the length direction, W denotes the width direction, and T denotes the height direction of an element body of the multilayer ceramic capacitor. The element body will be described below in detail.

To mitigate such acoustic noise, some solutions, such as that disclosed in Japanese Unexamined Patent Application Publication No. 2014-132633, have attempted to adjust the internal stacking structure of the dielectric layers and inner electrode layers—for example, by utilizing an asymmetric stacking arrangement. However, the inventors have identified that such internal modifications can increase the complexity of the manufacturing process, which may lead to a decrease in production efficiency and yield.

In view of these observations, the present disclosure provides an electronic component and a method of manufacturing the same that effectively suppresses the transmission of vibrations to a mounting substrate. As described in the embodiments below, this is achieved through unique outer electrode geometries that control solder wetting behavior, thereby reducing acoustic noise without necessitating complex internal stacking structures that would otherwise hinder production efficiency.

### Embodiments

### A. Configuration of Multilayer Ceramic Capacitor

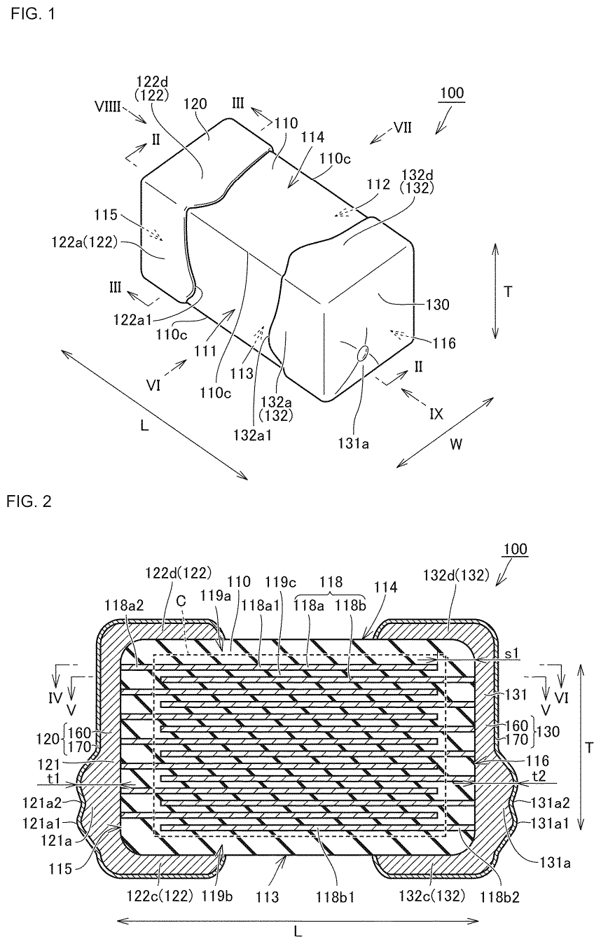

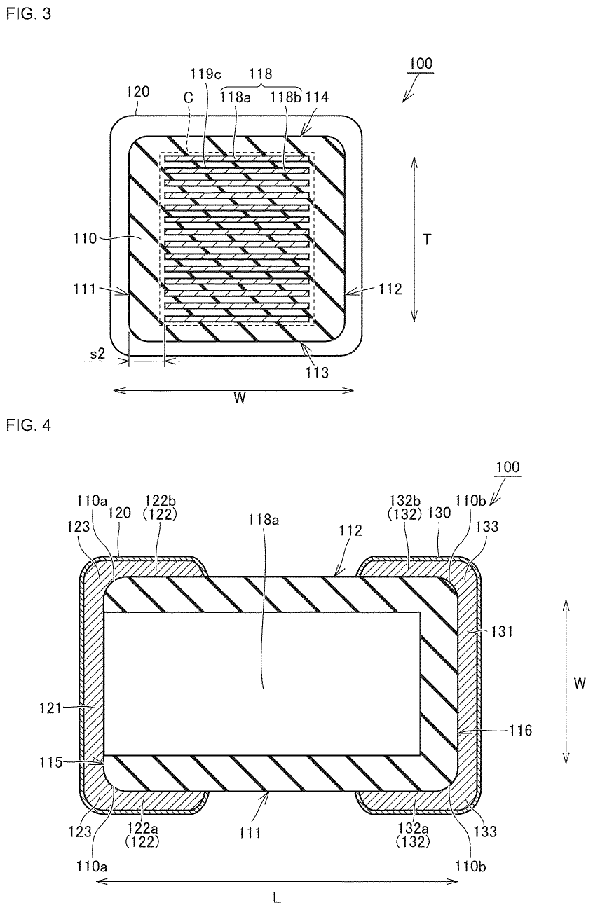

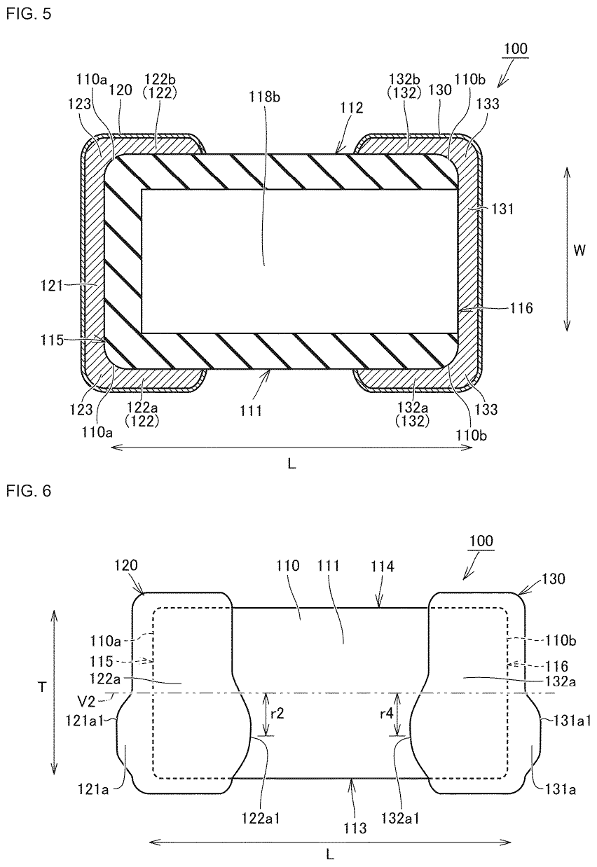

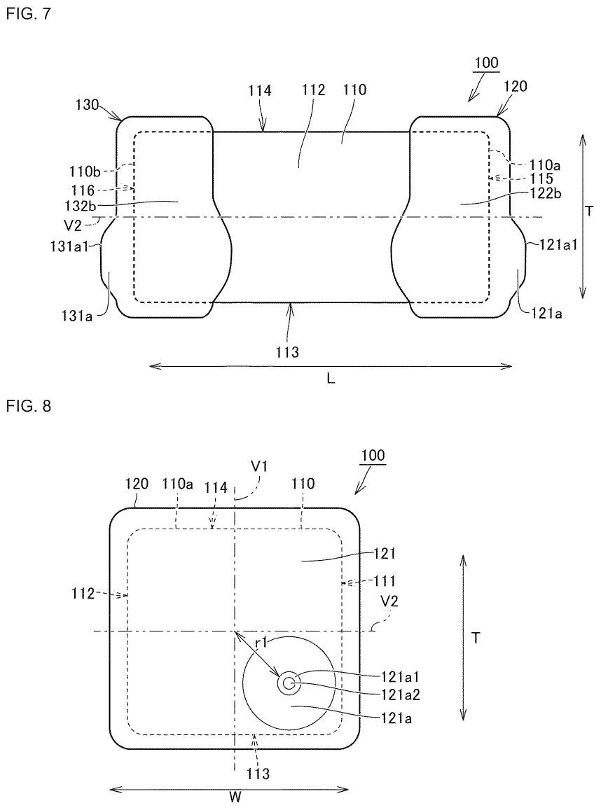

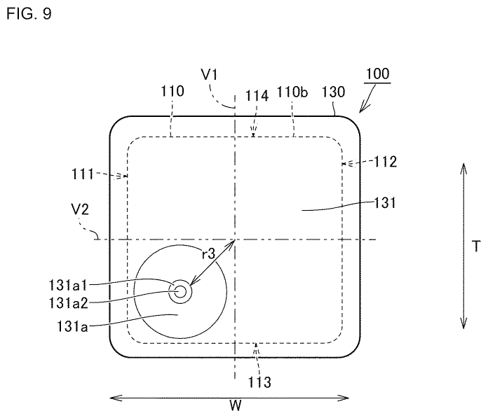

FIG. 1 is a schematic external perspective view of a multilayer ceramic capacitor according to an embodiment. FIG. 2 is a schematic sectional view taken along line II-II in FIG. 1. FIG. 3 is a schematic sectional view taken along line III-III in FIG. 1. FIG. 4 is a schematic sectional view taken along line IV-IV in FIG. 2. FIG. 5 is a schematic sectional view taken along line V-V in FIG. 2. FIG. 6 is a schematic view as seen in the direction of arrow VI in FIG. 1. FIG. 7 is a schematic view as seen in the direction of arrow VII in FIG. 1. FIG. 8 is a schematic view as seen in the direction of arrow VIII in FIG. 1. FIG. 9 is a schematic view as seen in the direction of arrow IX in FIG. 1. First, referring to FIGS. 1 to 9, the configuration of a multilayer ceramic capacitor 100 according to the present embodiment will be described.

As illustrated in FIGS. 1 to 9, the multilayer ceramic capacitor 100 according to the present embodiment includes an element body 110 and an outer electrode. The outer electrode includes a first outer electrode 120 and a second outer electrode 130.

The element body 110 has a substantially rectangular-parallelepiped shape. The element body 110 has a first side surface 111 and a second side surface 112 that face each other in the width direction W, a third side surface 113 and a fourth side surface 114 that face each other in the height direction T perpendicular to the width direction W, and a first end surface 115 and a second end surface 116 that face each other in the length direction L perpendicular to the width direction W and the height direction T. In the present embodiment, the width direction W corresponds to a first direction and the height direction T corresponds to a second direction.

The element body 110 includes a first-end ridgeline portion 110a, a second-end ridgeline portion 110b, and a side ridgeline portion 110c.

The first-end ridgeline portion 110a is a portion where the first end surface 115 intersects each of the first side surface 111, the second side surface 112, the third side surface 113, and the fourth side surface 114. The second-end ridgeline portion 110b is a portion where the second end surface 116 intersects each of the first side surface 111, the second side surface 112, the third side surface 113, and the fourth side surface 114. The side ridgeline portion 110c is a portion where two surfaces, among the first side surface 111, the second side surface 112, the third side surface 113, and the fourth side surface 114, that are adjacent to each other intersect.

The element body 110 includes a plurality of corner portions. The corner portions are portions where three surfaces of the element body 110 intersect. That is, the corner portions are portions where three surfaces, among the first side surface 111, the second side surface 112, the third side surface 113, the fourth side surface 114, the first end surface 115, and the second end surface 116, that are adjacent to each other intersect.

Each of the first-end ridgeline portion 110a, the second-end ridgeline portion 110b, the side ridgeline portion 110c, and the corner portions may be rounded.

The first end surface 115 and the second end surface 116 have sufficiently large sizes. To be more specific, the dimension of the element body 110 in the width direction W may be greater than or equal to 2.5 mm and less than or equal to 3.2 mm. The dimension of the element body 110 in the height direction T may be greater than or equal to 2.5 mm and less than or equal to 3.2 mm.

The dimension of the element body 110 in the length direction L may be greater than or equal to 3.05 mm and less than or equal to 3.2 mm.

The element body 110 has, for example, a size such that the dimension in the length direction L is 3.1 mm, the dimension in the width direction W is 2.5 mm, and the dimension in the height direction T is 2.5 mm. The sizes each include a tolerance.

The first outer electrode 120 is provided on the first end surface 115 and on a part of each of the first side surface 111, the second side surface 112, the third side surface 113, and the fourth side surface 114. The second outer electrode 130 is provided on the second end surface 116 and on a part of each of the first side surface 111, the second side surface 112, the third side surface 113, and the fourth side surface 114.

Detailed configurations of the first outer electrode 120 and the second outer electrode 130 will be described below in detail.

As illustrated in FIGS. 2 and 3, the element body 110 includes a plurality of inner electrode layers 118 and a plurality of dielectric layers that are alternately stacked in the height direction T. In other words, the height direction T coincides with the stacking direction in the present embodiment.

The plurality of dielectric layers include a first outer layer 119a including the fourth side surface 114, a second outer layer 119b including the third side surface 113, and an inner layer 119c that is positioned between the inner electrode layers 118 that are adjacent to each other in the height direction T. The number of the plurality of dielectric layers be greater than or equal to 300 and less than or equal to 800. The thickness of each of the first outer layer 119a and the thickness of the second outer layer 119b may be greater than or equal to 20 μm and less than or equal to 50 μm. The thickness of the inner layer 119c may be greater than or equal to 3 μm and less than or equal to 10 μm.

For example, as the ceramic material of each of the plurality of dielectric layers, a dielectric ceramic containing a component such as BaTiO₃, CaTiO₃, SrTiO₃, or CaZrO₃ may be used. A material that contains any of these as a main component and an additional subcomponent such as a Mn compound, an Fe compound, a Cr compound, a Co compound, or a Ni compound may be used.

In the present embodiment, the first outer layer 119a, the second outer layer 119b, and the inner layer 119c are made of substantially the same ceramic-based materials. The term “substantially the same ceramic-based materials” means materials in which raw ceramic materials are mixed in substantially the same ratio, and includes the meaning that the materials may have variations in ceramic composition due to variation in mixing ratio and processing step.

The plurality of inner electrode layers 118 include a plurality of first inner electrode layers 118a and a plurality of second inner electrode layers 118b. In the element body 110, the first inner electrode layers 118a and the second inner electrode layers 118b are alternately stacked in the height direction T. Each of the first inner electrode layers 118a and the second inner electrode layers 118b is provided parallel to the length direction L and the width direction W. The inner layer 119c is disposed between the first inner electrode layer 118a and the second inner electrode layer 118b that are adjacent to each other in the height direction T. That is, the first inner electrode layer 118a and the second inner electrode layer 118b that are adjacent to each other in the height direction T face each other with the inner layer 119c therebetween.

The first inner electrode layers 118a are extended to the first end surface 115. The first end surface 115 is covered by the first outer electrode 120. The first outer electrode 120 is electrically connected the first inner electrode layers 118a. The second inner electrode layers 118b are extended to the second end surface 116. The second end surface 116 is covered by the second outer electrode 130. The second outer electrode 130 is electrically connected to the second inner electrode layers 118b.

FIGS. 2 and 3 illustrate an example in which seven first inner electrode layers 118a and seven second inner electrode layers 118b are provided. However, the number of the first inner electrode layers 118a and the number of the second inner electrode layers 118b are not particularly limited to seven. The sum of the number of the first inner electrode layers 118a and the number of the second inner electrode layers 118b may be greater than or equal to 300 and less than or equal to 600. The thickness of each of the first inner electrode layers 118a and the second inner electrode layers 118b may be greater than or equal to 0.9 μm and less than or equal to 10 μm.

The first inner electrode layers 118a each include a first facing portion 118a1 and a first extended portion 118a2. The first facing portion 118a1 faces the second inner electrode layer 118b adjacent thereto in the height direction T. The first extended portion 118a2 connects the first facing portion 118a1 and the first outer electrode 120. The first extended portion 118a2 is extended to the first end surface 115. The first facing portion 118a1 and the first extended portion 118a2 are integrally formed.

The second inner electrode layers 118b each include a second facing portion 118b1 and a second extended portion 118b2. The second facing portion 118b1 faces the first inner electrode layer 118a adjacent thereto in the height direction T. The second extended portion 118b2 connects the second facing portion 118b1 and the second outer electrode 130. The second extended portion 118b2 is extended to the second end surface 116. The second facing portion 118b1 and the second extended portion 118b2 are integrally formed.

Each of the first inner electrode layers 118a and the second inner electrode layers 118b may include a metal selected from the group consisting of Ni, Cu, Ag, Pd, and Au or an alloy including the metal. An example of the alloy is an alloy of Ag and Pd. In the present embodiment, each of the first inner electrode layers 118a and the second inner electrode layers 118b includes Ni as a main component. Each of the first inner electrode layers 118a and the second inner electrode layers 118b may further include dielectric particles whose composition is substantially the same as that of a ceramic included in the dielectric layer. Each of the first inner electrode layers 118a and the second inner electrode layers 118b may include Sn at the interface with the dielectric layer.

The element body 110 includes an inner layer portion C. The inner layer portion C has an electrostatic capacity because the first facing portions 118a1 of the first inner electrode layers 118a and the second facing portions 118b1 of the second inner electrode layers 118b are stacked in the height direction T.

Here, the dimension of the first outer layer 119a in the height direction T and the dimension of the second outer layer 119b in the height direction T are substantially the same. Therefore, the inner layer portion C, which is interposed between the first outer layer 119a and the second outer layer 119b in the height direction T, is positioned at the center of the element body 110 in the height direction T.

The distance s1 (see FIG. 2) between an end portion of the first inner electrode layer 118a on the second end surface 116 side and the second end surface 116 may be greater than or equal to 1.6 mm and less than or equal to 6.0 mm. The same applies to the distance between an end portion of the second inner electrode layer 118b on the first end surface 115 side and the first end surface 115.

The distance s2 (see FIG. 3) between the first side surface 111 and the first and second inner electrode layers 118a and 118b may be greater than or equal to 2.5 mm and less than or equal to 3.0 mm. The same applies to the distance between the second side surface 112 and the first and second inner electrode layers 118a and 118b.

### B. Detailed Configuration of Outer Electrode

Hereafter, referring to FIGS. 1 to 9, the detailed configuration of the outer electrode will be described. As described above, the outer electrode includes the first outer electrode 120 and the second outer electrode 130.

The first outer electrode 120 and the second outer electrode 130 each include an underlying electrode layer 160 and a plating layer 170 that covers the underlying electrode layer 160.

The underlying electrode layer 160 includes at least one of a baked layer, a resin layer, a thin film layer, and the like. In the present embodiment, the underlying electrode layer 160 is a baked layer.

The baked layer includes a glass component and a metal component. As the metal component, a metal selected from the group consisting of Ni, Cu, Ag, Pd, and Au or an alloy including the metal, such as an alloy of Ag and Pd, may be used. The glass component includes at least one of Si and Zn.

The baked layer may include a plurality of layers that are stacked. The baked layer may be a layer formed by applying an electroconductive paste to the element body 110 and then baking the electroconductive paste, or may be a layer formed by being fired simultaneously with the inner electrode layers 118.

The plating layer 170 is disposed on the underlying electrode layer 160. It is possible to use, as the material of the plating layer 170, a metal selected from the group consisting of Ni, Cu, Ag, Pd, and Au or an alloy or the like including the metal. As an example, it is possible to use an alloy of Ag and Pd as the material of the plating layer 170.

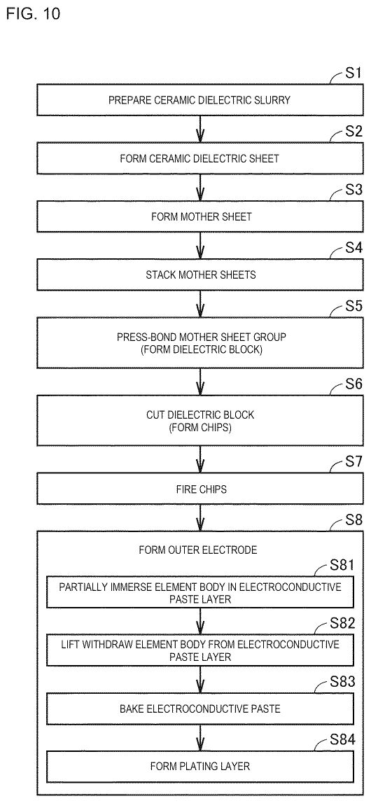

A resin layer including a metal filler may be further provided between the underlying electrode layer 160, which is a baked layer, and the plating layer 170. The resin layer can be formed through steps similar to those of forming the underlying electrode layer 160 (see steps S811 to S813 in FIG. 10 described below) in a method of manufacturing a multilayer ceramic capacitor according to the present embodiment described below.

In the present embodiment, the plating layer 170 includes a Ni layer that is positioned on the underlying electrode layer 160 side and a Sn layer that is positioned on a side opposite to the underlying electrode layer 160 side. To be specific, the plating layer 170 has a double layer structure in which a Sn plating layer is formed on a Ni plating layer.

The Ni plating layer can prevent an outer electrode from being eroded by solder that is used when the underlying electrode layer 160 is mounted on the substrate of the multilayer ceramic capacitor 100. The Sn plating layer can improve the wettability of solder in the mounting operation and thus can facilitate mounting of the multilayer ceramic capacitor 100.

The first outer electrode 120 includes a first-end first outer electrode 121, a side first outer electrode 122, and a ridgeline-portion first outer electrode 123.

The side first outer electrode 122 includes a first-side first outer electrode 122a, a second-side first outer electrode 122b, a third-side first outer electrode 122c, and a fourth-side first outer electrode 122d.

The first-end first outer electrode 121 is positioned on the first end surface 115. The first-side first outer electrode 122a is positioned on a portion of the first side surface 111 positioned on the first end surface 115 side. The second-side first outer electrode 122b is positioned on a portion of the second side surface 112 positioned on the first end surface 115 side. The third-side first outer electrode 122c is positioned on a portion of the third side surface 113 positioned on the first end surface 115 side. The fourth-side first outer electrode 122d is positioned on a portion of the fourth side surface 114 positioned on the first end surface 115 side. The ridgeline-portion first outer electrode 123 is positioned on the first-end ridgeline portion 110a.

The side first outer electrode 122 is connected to the first-end first outer electrode 121 via the ridgeline-portion first outer electrode 123.

As illustrated in FIG. 2 and FIGS. 6 to 8, the first-end first outer electrode 121 includes a first-end protruding portion 121a. The first-end protruding portion 121a protrudes in a direction away from the first end surface 115 in the length direction L. In the present embodiment, the first-end protruding portion 121a has a shape that gently bulges in a substantially conical shape from the surrounding portion. In particular, the first-end protruding portion 121a is configured as a tapered protrusion that increases in thickness in the length direction L as it extends from the ridgeline portion 110a toward the center. Specifically, the protrusion defines a substantially frustoconical shape wherein the first apex portion 121a1 forms an annular crest surrounding a central first recessed portion 121a2.

The first-end protruding portion 121a includes a first apex portion 121a1 that is a portion that protrudes farthest in the length direction L. The first apex portion 121a1 is the thickest portion of the first outer electrode 120. When seen in the length direction L, the first apex portion 121a1 is positioned in an annular shape. The first-end protruding portion 121a includes a first recessed portion 121a2 that is surrounded by the first apex portion 121a1. As used herein, the “annular shape” of the first apex portion 121a1 refers to a ring-like ridge that surrounds the first recessed portion 121a2. This ridge may be continuous, forming a complete circular or oval boundary, or discontinuous, comprising a series of discrete protruding high points that collectively define an annular distribution on the first end surface 115. Thus, the first apex portion 121a1 may define a continuous or discontinuous ring-like ridge surrounding the first recessed portion 121a2, or may include a plurality of discrete high points collectively forming an annular distribution on the first end surface.

As illustrated in FIG. 8, a first imaginary plane or width-bisecting plane V1 is defined as an imaginary plane that bisects the element body 110 in the width direction W. A second imaginary plane or height-bisecting plane V2 is defined as an imaginary plane that bisects the element body 110 in the height direction T. In this case, when seen in the length direction L, the first apex portion 121a1 does not overlap the first imaginary plane V1 and the first-end ridgeline portion 110a and is positioned closer than the second imaginary plane V2 to the third side surface 113. In the present embodiment, the first apex portion 121a1 is disposed at a position closer than the center of the element body 110 to the first side surface 111 in the width direction W.

When seen in the length direction L, the distance r1 (see FIG. 8) between the center of the element body 110 and a portion of the first apex portion 121a1 nearest to the center may satisfy the condition 0.1×S0≤r1≤0.4×S0, where S0 is the smaller of the dimension of the element body 110 in the height direction T and the dimension of the element body 110 in the width direction W.

As illustrated in FIGS. 1 and 6, an edge portion of the first-side first outer electrode 122a that is positioned near the center of the element body 110 in the length direction L includes a first curved portion 122a1. The first curved portion 122a1 projects toward the center of the element body 110 in the length direction L.

A portion of the first curved portion 122a1 that projects farthest toward the center of the element body 110 in the length direction L is positioned closer than the second imaginary plane V2 to the third side surface 113.

The distance r2 (see FIG. 6) between the portion of the first curved portion 122a1 that projects farthest and the second imaginary plane V2 in the height direction T satisfy the condition 0.1×T0≤r2≤0.4×T0, where T0 is the dimension of the element body 110 in the height direction T.

As illustrated in FIG. 7, an edge portion of the second-side first outer electrode 122b that is positioned near the center of the element body 110 in the length direction L also includes a curved portion. The curved portion has a configuration that is substantially mirror symmetric to the first curved portion 122a1 with respect to the first imaginary plane V1.

An edge portion of the third-side first outer electrode 122c that is positioned near the center of the element body 110 in the length direction L also includes a curved portion. The curved portion projects toward the center of the element body 110 in the length direction L. A portion of the curved portion that protrudes farthest toward the center of the element body 110 in the length direction L is positioned closer than the first imaginary plane V1 to the first side surface 111.

As illustrated in FIG. 1, an edge portion of the fourth-side first outer electrode 122d that is positioned near the center of the element body 110 in the length direction L also includes a curved portion. The curved portion has a configuration that is substantially mirror symmetric to the curved portion of the third-side first outer electrode 122c with respect to the second imaginary plane V2.

The second outer electrode 130 includes a second-end second outer electrode 131, a side second outer electrode 132, and a ridgeline-portion second outer electrode 133.

The side second outer electrode 132 includes a first-side second outer electrode 132a, a second-side second outer electrode 132b, a third-side second outer electrode 132c, and a fourth-side second outer electrode 132d.

The second-end second outer electrode 131 is positioned on the second end surface 116. The first-side second outer electrode 132a is positioned on a portion of the first side surface 111 positioned on the second end surface 116 side. The second-side second outer electrode 132b is positioned on a portion of the second side surface 112 positioned on the second end surface 116 side. The third-side second outer electrode 132c is positioned on a portion of the third side surface 113 positioned on the second end surface 116 side. The fourth-side second outer electrode 132d is positioned on a portion of the fourth side surface 114 positioned on the second end surface 116 side. The ridgeline-portion second outer electrode 133 is positioned on the second-end ridgeline portion 110b.

The side second outer electrode 132 is connected to the second-end second outer electrode 131 via the ridgeline-portion second outer electrode 133.

As illustrated in FIGS. 2, 6, 7, and 9, the second-end second outer electrode 131 includes a second-end protruding portion 131a. The second-end protruding portion 131a protrudes in a direction away from the second end surface 116 in the length direction L. In the present embodiment, the second-end protruding portion 131a has a shape that gently bulges in a substantially conical shape from the surrounding portion. In particular, the second-end protruding portion 131a is configured as a tapered protrusion that increases in thickness in the length direction L as it extends from the ridgeline portion 110b toward the center. Specifically, the protrusion defines a substantially frustoconical shape wherein the first apex portion 121a1 forms an annular crest surrounding a central first recessed portion 131a2.

The second-end protruding portion 131a includes a second apex portion 131a1 that is a portion that protrudes farthest in the length direction L. The second apex portion 131a1 is the thickest portion of the second outer electrode 130. When seen in the length direction L, the second apex portion 131a1 is positioned in an annular shape. The second-end protruding portion 131a includes a second recessed portion 131a2 that is surrounded by the second apex portion 131a1.

When seen in the length direction L, the second apex portion 131a1 does not overlap the first imaginary plane V1 and the second-end ridgeline portion 110b, and is positioned closer than the second imaginary plane V2 to the third side surface 113. In the present embodiment, the second apex portion 131a1 is disposed at a position closer than the center of the element body 110 to the first side surface 111 in the width direction W. When seen in the length direction L, the second apex portion 131a1 is disposed at a position that substantially overlaps the position of the first apex portion 121a1.

When seen in the length direction L, the distance r3 (see FIG. 9) between the center of the element body 110 and a portion of the second apex portion 131a1 nearest to the center may satisfy the condition 0.1×S0≤r3≤0.4×S0.

As illustrated in FIGS. 1 and 6, an edge portion of the first-side second outer electrode 132a that is positioned near the center of the element body 110 in the length direction L includes a second curved portion 132a1. The second curved portion 132a1 projects toward the center of the element body 110 in the length direction L.

A portion of the second curved portion 132a1 that projects farthest toward the center of the element body 110 in the length direction L is positioned closer than the second imaginary plane V2 to the third side surface 113.

The distance r4 (see FIG. 6) between the portion of the second curved portion 132a1 that projects farthest and the second imaginary plane V2 in the height direction T satisfy the condition 0.1×T0≤r4≤0.4×T0.

As illustrated in FIG. 7, an edge portion of the second-side second outer electrode 132b that is positioned near the center of the element body 110 in the length direction L also includes a curved portion. The curved portion has a configuration that is substantially mirror symmetric to the second curved portion 132a1 with respect to the first imaginary plane V1.

An edge portion of the third-side second outer electrode 132c that is positioned near the center of the element body 110 in the length direction L also includes a curved portion. The curved portion projects toward the center of the element body 110 in the length direction L. A portion of the curved portion that protrudes farthest toward the center of the element body 110 in the length direction L is positioned closer than the first imaginary plane V1 to the first side surface 111.

As illustrated in FIG. 1, an edge portion of the fourth-side second outer electrode 132d that is positioned near the center of the element body 110 in the length direction L also includes a curved portion. The curved portion has a configuration that is substantially mirror symmetric to the curved portion of the third-side second outer electrode 132c with respect to the second imaginary plane V2.

Here, when the thickness of the first-end first outer electrode 121 and the thickness of the second-end second outer electrode 131 are smaller than a predetermined thickness, it is difficult to ensure the reliability of the first outer electrode 120 and the second outer electrode 130 as extension electrodes. On the other hand, on the assumption that the size of the outer shape of the multilayer ceramic capacitor 100 is not to be changed, when the thickness of the first-end first outer electrode 121 and the thickness of the second-end second outer electrode 131 are increased, the size of the inner layer portion C decreases accordingly, and, as a result, it is difficult for the multilayer ceramic capacitor 100 to have a sufficient electrostatic capacity.

From this viewpoint, the maximum thickness t1 (see FIG. 2) of the first-end first outer electrode 121 may satisfy the condition 0.0006×L0≤t1≤0.015×L0, where L0 is the dimension of the element body 110 in the length direction L. The maximum thickness t1 may be greater than or equal to 20 μm and less than or equal to 120 μm. The maximum thickness t2 (see FIG. 2) of the second-end second outer electrode 131 may satisfy the 0.0006×L0≤t2≤0.015×L0. The maximum thickness t2 may be greater than or equal to 20 μm and less than or equal to 120 μm. A difference between the maximum thickness t1 and the maximum thickness t2 may be greater than or equal to 20 μm. In the present embodiment, the maximum thickness t1 is greater than the maximum thickness t2.

The thickness of a portion of the first-end first outer electrode 121 excluding the first-end protruding portion 121a may be greater than the thickness of the side first outer electrode 122. The thickness of a portion of the second-end second outer electrode 131 excluding the second-end protruding portion 131a may be greater than the thickness of the side second outer electrode 132.

In this way, by making the thickness of the first-end first outer electrode 121 and the thickness of the second-end second outer electrode 131 relatively large, it is possible to reduce acoustic noise. By making the thickness of the side first outer electrode 122 and the thickness of the side second outer electrode 132 relatively small, the size of the inner layer portion C in the W-T plane, which is perpendicular to the length direction L, may be increased, increasing the electrostatic capacity of the multilayer ceramic capacitor 100.

Each of the thicknesses of the outer electrodes may be estimated by polishing the multilayer ceramic capacitor 100 to expose the L-T cross section of the multilayer ceramic capacitor 100 at a predetermined position in the width direction W, and by observing the cross section by using an optical microscope or the like. Each of the thicknesses may be estimated by polishing the multilayer ceramic capacitor 100 to expose the L-W cross section of the multilayer ceramic capacitor 100 at a predetermined position in the height direction T, and by observing the cross section.

### C. Method of Manufacturing Multilayer Ceramic Capacitor

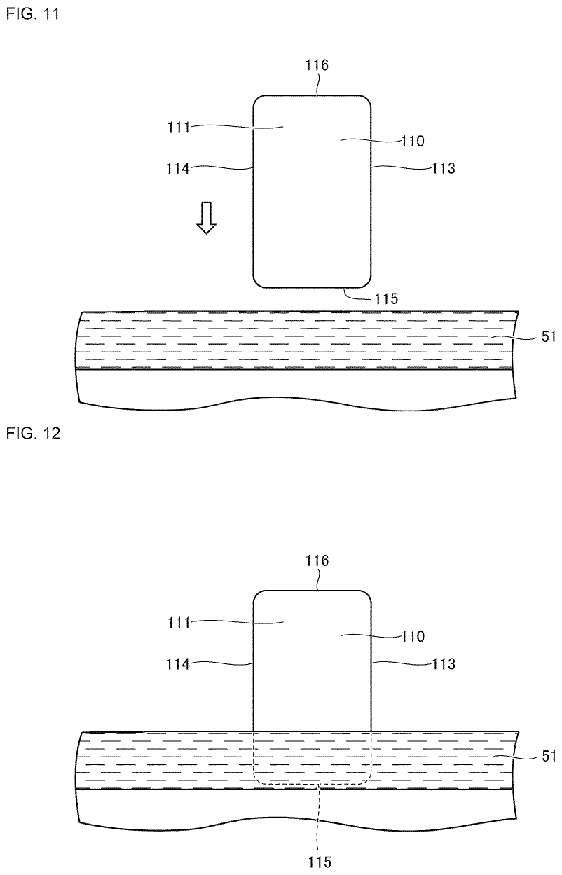

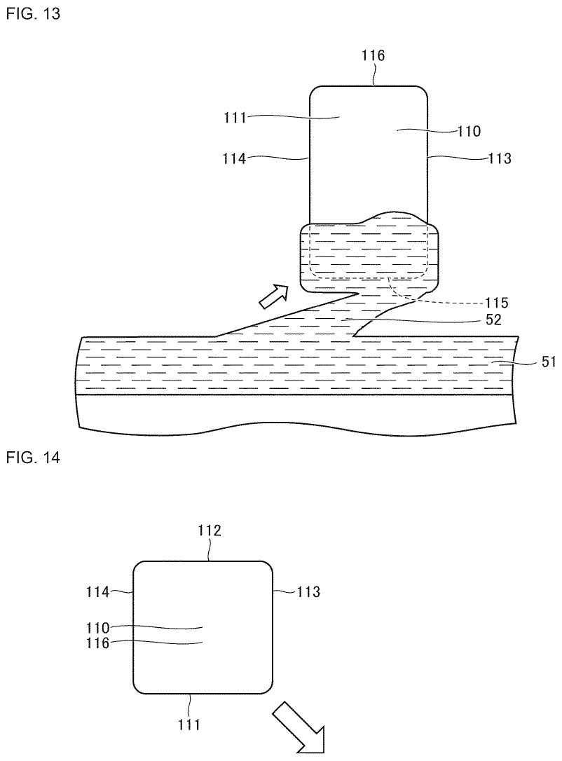

FIG. 10 is a flowchart illustrating a method of manufacturing a multilayer ceramic capacitor according to the embodiment. FIGS. 11 to 15 are each a schematic view for illustrating a corresponding step of the manufacturing flow illustrated in FIG. 10. FIG. 14 is a schematic view of the element body 110 as seen from above in the vertical direction. Next, referring to FIGS. 10 to 15, a method of manufacturing the multilayer ceramic capacitor 100 according to the present embodiment will be described.

First, as illustrated in FIG. 10, ceramic dielectric slurry is prepared (step S1). To be specific, ceramic dielectric powder, additive powder, a binder resin, a solution, and the like are dispersedly mixed. Thus, ceramic dielectric slurry is prepared.

The ceramic dielectric powder includes, for example, dielectric particles of BaTiO₃, CaTiO₃, SrTiO₃, CaZrO₃, CaHfO₃, or the like having a perovskite structure. The additive powder includes, for example, at least one of a Si compound, a Mg compound, a Mn compound, an Fe compound, a Cr compound, a Ni compound, and a Co compound. As the binder resin, it is possible to use a polyurethane resin, a urea resin, a melamine resin, an epoxy resin, an acetic acid resin, an acrylic-based resin, or an aqueous polymer such as polyvinyl alcohol (PVA) or polyvinyl butyral (PVB). One of these may be used alone, or a mixture of two or more of these may be used. The ceramic dielectric slurry may be either of solvent-based slurry or water-based slurry. When water-based slurry is to be used as the ceramic dielectric slurry, the ceramic dielectric slurry is prepared by mixing a water-soluble binder, a dispersant, a dielectric material dissolved in water, and the like.

Next, a ceramic dielectric sheet is formed (step S2). To be specific, the ceramic dielectric slurry is shaped into a sheet on a carrier film by using a die coater, a gravure coater, a micro-gravure coater, or the like, and is dried. Thus, a ceramic dielectric sheet is formed.

Next, a mother sheet is formed (step S3). To be specific, an electroconductive paste is applied to the ceramic dielectric sheet so as to have a predetermined pattern. Thus, a mother sheet having a predetermined inner electrode pattern on the ceramic dielectric sheet is formed. The electroconductive paste includes Ni powder, a solvent, a dispersant, a binder, and the like, and is prepared to have a constant viscosity. As the binder, PVA, PVB, or the like is used. As a method of applying the electroconductive paste, it is possible to use a screen-printing method, an inkjet method, a gravure-printing method, and the like. As a mother sheet, in addition to the mother sheet having the inner electrode pattern, a ceramic dielectric sheet that is not subjected to step S3 is also prepared.

Next, a plurality of mother sheets are stacked (step S4). To be specific, a predetermined number of mother sheets each of which does not have an inner electrode pattern and includes only a ceramic dielectric sheet are stacked. On the stack of mother sheets, a predetermined number of mother sheets each of which has an inner electrode pattern are stacked. Further on the stack of mother sheets, a predetermined number of mother sheets each of which does not have an inner electrode pattern and includes only a ceramic dielectric sheet are stacked. Thus, a mother sheet group is configured.

Next, a dielectric block is formed by pressure-bonding the mother sheet group (step S5). To be specific, the mother sheet group is pressed in the stacking direction by using an isostatic press or a rigid-body press to be pressure-bonded. Thus, the dielectric block is formed. At this time, the ceramic dielectric sheets are closely bonded to each other because the ceramic dielectric sheets are pressed at a predetermined temperature. Moreover, a ceramic dielectric sheet of a certain thickness is placed on the outermost layer in the stacking direction and pressed. Thus, it is possible to protect dielectric sheets each of which has an inner electrode pattern.

Next, chips are formed by cutting the dielectric block (step S6). To be specific, the dielectric block is divided into chips by cutting the dielectric block in a matrix pattern by press-cutting, dicing, or laser cutting. The dielectric block may be cut in a state in which the dielectric block is heated and softened.

Next, the chips are fired (step S7). To be specific, as the chips are heated, a dielectric material and an electroconductive material included in the chips are fired and the element body 110 is formed. The firing temperature is, for example, higher than or equal to 900° C. and lower than or equal to 1300° C. The firing temperature is appropriately set in accordance with the dielectric material and the electroconductive material.

Next, an outer electrode is formed (step S8). This step includes steps S81 to S84 described below.

First, as illustrated in FIGS. 10 to 12, the element body 110 is partially immersed in an electroconductive paste layer 51 (step S81). To be specific, the element body 110 is partially immersed in the electroconductive paste layer 51 from the first end surface 115 side.

Next, as illustrated in FIG. 10 and FIGS. 13 to 15, the element body 110 is lifted from the electroconductive paste layer 51 (step S82). To be specific, the element body 110 is lifted from the electroconductive paste layer 51 while the element body 110 is moved relative to the electroconductive paste layer 51 in a direction from the fourth side surface 114 toward the third side surface 113 and from the second side surface 112 toward the first side surface 111.

Thus, the element body 110 is lifted diagonally upward from the electroconductive paste layer 51 in a state in which the electroconductive paste layer 51 and the element body 110 are connected to each other by an electroconductive paste 52 stretched from the electroconductive paste layer 51.

By lifting the element body 110 diagonally upward from the electroconductive paste layer 51 in this way, it is possible to cause the electroconductive paste 52 applied to the first side surface 111 to be thickly distributed on the third side surface 113 side in the height direction T. As a result, it is possible to provide the first-side first outer electrode 122a with the first curved portion 122a1. The same applies to a curved portion of the second-side first outer electrode 122b.

Moreover, by lifting the element body 110 diagonally upward from the electroconductive paste layer 51 in this way, it is possible to cause the electroconductive paste 52 applied to the third side surface 113 to be thickly distributed on the first side surface 111 side in the width direction W. As a result, it is possible to provide the third-side first outer electrode 122c with the curved portion. The same applies to a curved portion of the fourth-side first outer electrode 122d.

Furthermore, by lifting the element body 110 diagonally upward from the electroconductive paste layer 51 in this way, it is possible to cause the electroconductive paste 52 applied to the first end surface 115 to be thickly distributed on the first side surface 111 side in the width direction W and on the third side surface 113 side in the height direction T. As a result, it is possible to provide the first-end first outer electrode 121 with the first-end protruding portion 121a.

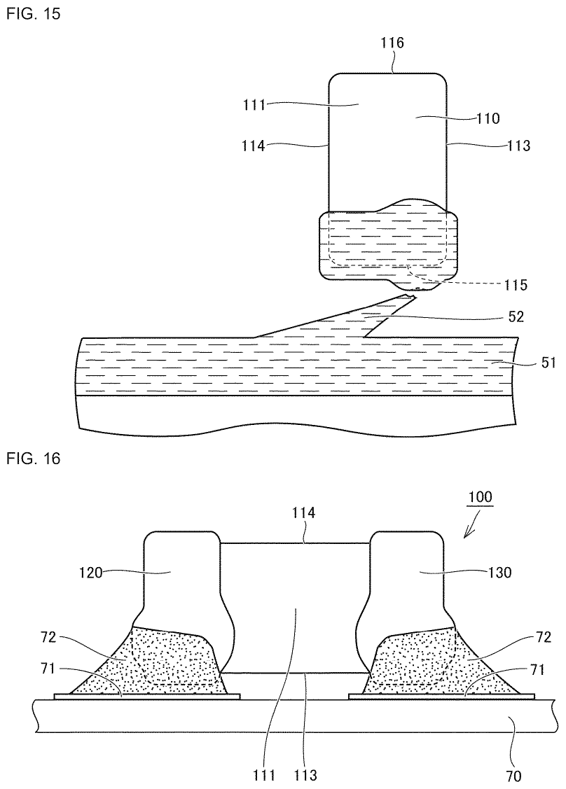

Then, when the element body 110 is further lifted diagonally upward from the electroconductive paste layer 51, the electroconductive paste 52, which has been stretched from the electroconductive paste layer 51, is torn apart (see FIG. 15). At this time, the electroconductive paste 52 is torn apart starting from an end of a portion corresponding to the first-end protruding portion 121a. As a result, the first-end protruding portion 121a is provided with the first recessed portion 121a2 and the first apex portion 121a1 that is positioned so as to surround the first recessed portion 121a2. This tearing apart of the electroconductive paste 52 is a controlled physical separation caused by the diagonal withdrawal speed and paste viscosity.

After step S82, partial immersion of the element body 110 in the electroconductive paste layer 51 and lifting of the element body 110 from the electroconductive paste layer 51 may be repeatedly performed further.

Next, step S81 and step S82 are performed also on a portion of the element body 110 on the second end surface 116 side.

Next, the electroconductive paste 52 applied to the element body 110 is baked (step S83). To be specific, the electroconductive paste 52 applied to the first end surface 115 and the surrounding area and to the second end surface 116 and the surrounding area is heated, and thus a baked layer is formed. The baking temperature is, for example, higher than or equal to 700° C. and lower than or equal to 900° C. The baking temperature can be changed as appropriate in accordance with the dielectric material and the electroconductive material.

Next, a plating layer is provided on a surface of the baked layer (step S84). Through the steps described above, it is possible to manufacture the multilayer ceramic capacitor 100 according to the present embodiment.

In the method of manufacturing the multilayer ceramic capacitor 100, an example in which the side first outer electrode 122 provided with the first curved portion 122a1 and other curved portions and the first-end first outer electrode 121 provided with the first-end protruding portion 121a are formed by lifting the element body 110 from the electroconductive paste layer 51 in a predetermined direction has been described. However, in view of facilitating forming of these, additionally appropriate adjustment of the viscosity the electroconductive paste 52 may be performed.

### D. Mounting of Multilayer Ceramic Capacitor

FIG. 16 is a schematic view illustrating a state in which the multilayer ceramic capacitor illustrated in FIG. 1 is mounted on a substrate. Next, referring to FIG. 16, an example of a method of mounting the multilayer ceramic capacitor 100 according to the present embodiment on a substrate 70 will be described.

As can be seen from FIG. 16, when the multilayer ceramic capacitor 100 is to be mounted on the substrate 70, first, a pair of electroconductive lands 71 are provided on a main surface of the substrate 70.

Next, the multilayer ceramic capacitor 100 is placed on the substrate 70 so that the first outer electrode 120 is positioned on one of the pair of lands 71 and the second outer electrode 130 is positioned on the other of the pair of lands 71. In the present embodiment, the multilayer ceramic capacitor 100 is placed on the substrate 70 so that the third side surface 113 faces the main surface of the substrate 70.

Next, the multilayer ceramic capacitor 100 placed on the substrate 70 is soldered. Thus, the multilayer ceramic capacitor 100 is fixed to the substrate 70 via solder 72 that has wetted and spread along the first outer electrode 120 and the second outer electrode 130.

### E. Summary

In the multilayer ceramic capacitor 100 according to the present embodiment, as described above, the first-end first outer electrode 121 includes the first-end protruding portion 121a, and, when seen in the length direction L, the first apex portion 121a1 of the first-end protruding portion 121a does not overlap the first imaginary plane V1 and the first-end ridgeline portion 110a and is positioned closer than the second imaginary plane V2 to the third side surface 113. Moreover, the first-side first outer electrode 122a includes the first curved portion 122a1, and a portion of the first curved portion 122a1 that projects farthest toward the center of the element body 110 in the length direction L is positioned closer than the second imaginary plane V2 to the third side surface 113.

With such a configuration, it is possible to provide the multilayer ceramic capacitor 100 with reduced acoustic noise while ensuring high production efficiency.

That is, when the multilayer ceramic capacitor 100 is being mounted on the substrate 70 as illustrated in FIG. 16, the solder 72 wets and spreads over the outer electrode to cover the surface of the outer electrode, and thus the multilayer ceramic capacitor 100 is fixed to the substrate 70 via the solder 72.

Here, in a case where the solder 72 wets and spreads so as to reach a central portion of the first-end first outer electrode 121 when seen in the length direction L, acoustic noise tends to be large compared with a case where the solder 72 does not reach the central portion of the first-end first outer electrode 121. This is because a central portion of the inner layer portion C of the element body 110 vibrates with the largest amplitude and therefore vibration of the element body 110 can be easily transmitted to the substrate 70 if the solder 72 is provided on the central portion of the first-end first outer electrode 121 that is a portion that overlaps the central portion when seen in the length direction L.

In this respect, in the multilayer ceramic capacitor 100 according to the present embodiment, the first apex portion 121a1 provided as described above interrupts wetting and spreading of the solder 72 upward along the first-end first outer electrode 121. Because the first apex portion 121a1 suppresses wetting and spreading of the solder 72 in this way, the amount of the solder 72 on the central portion of the first-end first outer electrode 121 is reduced, and, as a result, acoustic noise is reduced.

Moreover, because the first-side first outer electrode 122a includes the first curved portion 122a1 as described above, a part of the solder 72 that wets and spreads over the first outer electrode 120 wets and spreads so as to be guided toward the first curved portion 122a1. Also for this reason, it is possible to reduce the amount of solder 72 provided on the central portion of the first-end first outer electrode 121.

The second outer electrode 130 also has the advantageous effects of the first outer electrode 120 described above.

Furthermore, with the multilayer ceramic capacitor 100 according to the present embodiment, acoustic noise may be reduced as described above without displacing the position of the central portion of the inner layer portion C from the position of the central portion of the element body 110. In other words, aa number of dielectric sheets for forming the first outer layer 119a and the number of dielectric sheets for forming the second outer layer 119b need not differ from each other. Thus, the multilayer ceramic capacitor 100 with reduced acoustic noise while ensuring high production efficiency may be provided.

Accordingly, with the configuration described above, an electronic component with reduced acoustic noise while ensuring high production efficiency may be provided.

In the multilayer ceramic capacitor 100 according to the present embodiment, as described above, the first-end protruding portion 121a includes the first recessed portion 121a2. With such a configuration, a part of the solder 72 that wets and spreads over the first outer electrode 120 is guided toward the inside of the first recessed portion 121a2. Thus, the amount of the solder 72 provided on the central portion of the first-end first outer electrode 121 when seen in the length direction L is reduced, and, as a result, acoustic noise is reduced. The second outer electrode 130 also has the same advantageous effects.

Regarding the multilayer ceramic capacitor 100 according to the present embodiment, an example in which an edge portion of each of the first-side first outer electrode 122a, the second-side first outer electrode 122b, the third-side first outer electrode 122c, and the fourth-side first outer electrode 122d that is positioned near the center of the element body 110 in the length direction L includes a curved portion has been described. However, it is sufficient that at least an edge portion of the first-side first outer electrode 122a include a curved portion. Similarly, regarding the second outer electrode 130, it is sufficient that at least an edge portion of the first-side second outer electrode 132a include a curved portion.

Regarding the multilayer ceramic capacitor 100 according to the present embodiment, an example in which the first outer electrode 120 and the second outer electrode 130 each include the underlying electrode layer 160 and the plating layer 170 has been described. However, it is sufficient that the first outer electrode 120 and the second outer electrode 130 each include only the underlying electrode layer 160.

Regarding the multilayer ceramic capacitor 100 according to the present embodiment, an example in which the plurality of inner electrode layers 118 and the plurality of dielectric layers are alternately stacked in the height direction T has been described. However, the plurality of inner electrode layers 118 and the plurality of dielectric layers may be alternately stacked in the width direction W.

### First Modification

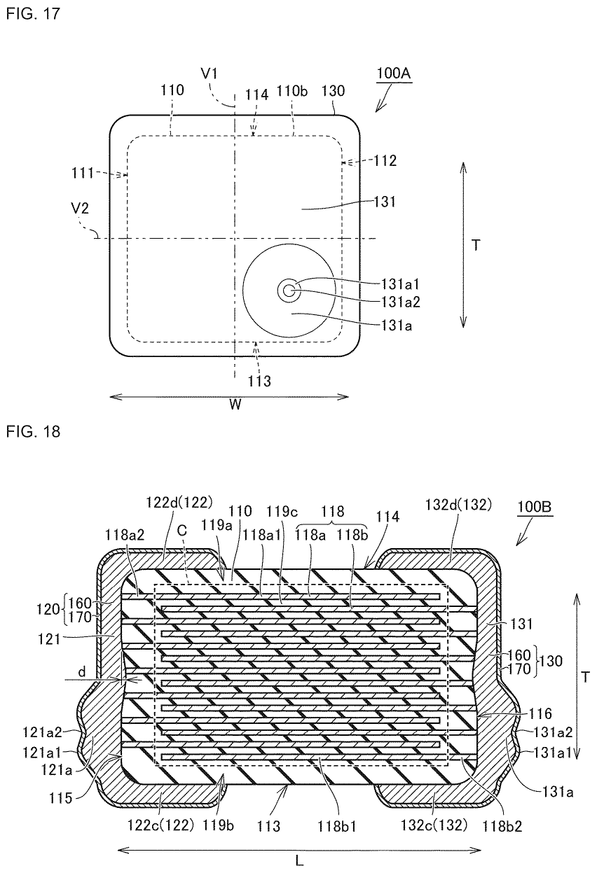

FIG. 17 is a schematic view of a multilayer ceramic capacitor according to a first modification. To be specific, FIG. 17 is a schematic view, corresponding to FIG. 9, of a multilayer ceramic capacitor according to the first modification. Hereafter, referring to FIG. 17, a multilayer ceramic capacitor 100A according to the first modification of the embodiment will be described.

As illustrated in FIG. 17, the multilayer ceramic capacitor 100A according to the present modification differs from the multilayer ceramic capacitor 100 according to the embodiment in the disposition of the second-end protruding portion 131a when seen in the length direction L.

To be more specific, in the multilayer ceramic capacitor 100A, when seen in the length direction L, the second apex portion 131a1 and the second-end protruding portion 131a including the second apex portion 131a1 are disposed at a position that is closer than the center of the element body 110 to the second side surface 112 in the width direction W.

Therefore, in the multilayer ceramic capacitor 100A, when seen in the length direction L, the first apex portion 121a1 of the first-end protruding portion 121a and the second apex portion 131a1 of the second-end protruding portion 131a do not overlap each other.

Also with such a configuration, advantageous effects similar to those of the embodiment can be obtained, and it is possible to provide an electronic component with reduced acoustic noise while ensuring high production efficiency.

Moreover, with such a configuration, it is possible to further reduce acoustic noise as follows. When seen in the length direction L, the position of a portion of the substrate 70 that vibrates most on the first outer electrode 120 side and the position of a portion of the substrate 70 that vibrates most on the second outer electrode 130 side are disposed to be displaced from each other. Thus, the maximum amount of warping of the substrate 70 due to vibration can be reduced, compared with a case where the first apex portion 121a1 and the second apex portion 131a1 overlap each other when seen in the length direction L.

The multilayer ceramic capacitor 100A according to the present modification can be manufactured by using a method similar to the method of manufacturing the multilayer ceramic capacitor 100 according to the embodiment.

### Second Modification

FIG. 18 is a schematic view of a multilayer ceramic capacitor according to a second modification. To be more specific, FIG. 18 is a schematic sectional view of a portion corresponding to FIG. 2 of the multilayer ceramic capacitor according to the embodiment. Hereafter, referring to FIG. 18, a multilayer ceramic capacitor 100B according to the second modification of the embodiment will be described.

As illustrated in FIG. 18, the multilayer ceramic capacitor 100B according to the present modification differs from the multilayer ceramic capacitor 100 according to the embodiment in the configuration of the first end surface 115 and the second end surface 116 of the element body 110.

To be more specific, in the multilayer ceramic capacitor 100B, a central portion of each of the first end surface 115 and the second end surface 116 is recessed. The depth d of the recessed portion may be less than or equal to 20 μm.

Also with such a configuration, advantageous effects similar to those of the embodiment can be obtained, and an electronic component with reduced acoustic noise while ensuring high production efficiency may be provided.

With such a configuration, when the element body 110 is partially immersed in the electroconductive paste layer 51 as described above (step S81), a portion the electroconductive paste 52 applied to the recessed portion tends to trap air bubbles. Therefore, in a case of manufacturing the multilayer ceramic capacitor 100B according to the present modification, the element body 110 may be partially immersed in the electroconductive paste layer 51 a plurality of times. This is because, by doing so, entrapment of such bubbles may be suppressed, forming an outer electrode that does not have a hollow space having a diameter greater than or equal to 1 μm.

In the present modification, an example in which a central portion of each of the first end surface 115 and the second end surface 116 is recessed has been described. However, only one of the first end surface 115 and the second end surface 116 may be recessed.

### Other Embodiments etc.

In each of the embodiment according to present disclosure and the modifications, a multilayer ceramic capacitor is described as an example of an electronic component. However, an electronic component according to each of the present embodiment and the modifications may be applied to, for example, a multilayer ceramic inductor, a multilayer ceramic thermistor, or the like. When the electronic component is a multilayer ceramic inductor, for example, the dielectric is made of a magnetic ceramic and an inner electrode is a coil-shaped conductor. When the electronic component is a multilayer ceramic thermistor, for example, the dielectric layer is made of a semiconductor ceramic.

The shape, configuration, size, number, material, and the like of each portion of the embodiment according to present disclosure and the modifications can be changed in various ways without departing from the gist of the present disclosure.

Moreover, characteristic configurations described in the embodiment according to present disclosure and the modifications can be naturally combined with each other without departing from the gist of the present disclosure.

The embodiment and the modifications are examples in all respects and are not limiting. The scope of the present invention is defined by the claims and includes all changes within the meanings of the claims and equivalents thereof.

What is claimed is:

1. An electronic component comprising:
an element body having a first end surface and a second end surface that face each other in a length direction, a first side surface and a second side surface that face each other in a first direction perpendicular to the length direction, and a third side surface and a fourth side surface that face each other in a second direction perpendicular to the length direction and the first direction,
the element body including a plurality of dielectric layers and a plurality of inner electrode layers that are stacked in one of the first direction and the second direction;
a first outer electrode disposed on the first end surface and on a part of each of the first side surface, the second side surface, the third side surface, and the fourth side surface; and
a second outer electrode disposed on the second end surface and on a part of each of the first side surface, the second side surface, the third side surface, and the fourth side surface,
wherein the element body includes
a first-end ridgeline portion defined by an intersection of the first end surface and each of the first side surface, the second side surface, the third side surface, and the fourth side surface, and
a second-end ridgeline portion defined by an intersection of the second end surface and each of the first side surface, the second side surface, the third side surface, and the fourth side surface,
wherein the first outer electrode at least includes
a first-end first outer electrode on the first end surface, and
a first-side first outer electrode connected to the first-end first outer electrode and on a part of the first side surface,
wherein the first-end first outer electrode includes a first-end protruding portion that protrudes in a direction away from the first end surface in the length direction,
wherein, relative to a first imaginary plane bisecting the element body in the first direction and a second imaginary plane bisecting the element body in the second direction, a first apex portion of the first-end protruding portion extending farthest in the length direction is spaced apart from the first imaginary plane and the first-end ridgeline portion when seen in the length direction and is positioned closer to the third side surface than to the second imaginary plane,
wherein an edge portion of the first-side first outer electrode proximate to a center of the element body in the length direction includes a first curved portion that projects toward the center of the element body in the length direction,
wherein a portion of the first curved portion projecting farthest toward the center of the element body in the length direction is positioned closer to the third side surface than to the second imaginary plane,
wherein the second outer electrode includes
a second-end second outer electrode on the second end surface, and
a first-side second outer electrode connected to the second-end second outer electrode and on a part of the first side surface,
wherein the second-end second outer electrode includes a second-end protruding portion that protrudes in a direction away from the second end surface in the length direction,
wherein, relative to the first imaginary plane and the second-end ridgeline portion, a second apex portion of the second-end protruding portion that extending farthest in a direction away from the second end surface in the length direction is spaced apart from the first imaginary plane and the second-end ridgeline portion when seen in the length direction and is positioned closer to the third side surface than to the second imaginary plane,
wherein an edge portion of the first-side second outer electrode proximate to the center of the element body in the length direction includes a second curved portion that projects toward the center of the element body in the length direction, and
wherein a portion of the second curved portion projecting farthest toward the center of the element body in the length direction is positioned closer to the third side surface than to the second imaginary plane.

2. The electronic component according to claim 1, wherein the first apex portion and the second apex portion do not overlap each other when seen in the length direction.

3. The electronic component according to claim 1,
wherein the first apex portion is a thickest portion of the first outer electrode, and
wherein the second apex portion is a thickest portion of the second outer electrode.

4. The electronic component according to claim 1,
wherein a dimension of the element body in the first direction is greater than or equal to 2.5 mm, and
wherein a dimension of the element body in the second direction is greater than or equal to 2.5 mm.

5. The electronic component according to claim 1,
wherein the first-end protruding portion includes a first recessed portion that is surrounded by the first apex portion, and
wherein the second-end protruding portion includes a second recessed portion that is surrounded by the second apex portion.

6. The electronic component according to claim 1, wherein, in a width direction, the first apex portion is disposed at a position closer to the first side surface than the center of the element body is to the first side surface.

7. The electronic component according to claim 1, wherein at least one of the first end surface and the second end surface includes a recessed portion at a central portion thereof.

8. The electronic component according to claim 1, wherein
the first-end protruding portion has a frustoconical shape wherein the first apex portion forms an annular crest surrounding a central first recessed portion, and
the second-end protruding portion has a frustoconical shape wherein the second apex portion forms an annular crest surrounding a central second recessed portion.

9. The electronic component according to claim 1, wherein
S0 is a smaller of a dimension of the element body in a first direction orthogonal to the length direction and a dimension of the element body in a second direction orthogonal to the first direction and the length direction,
r1 is a distance in the length direction between the center of the element body and a portion of the first apex portion nearest to the center, and
0.1×S0≤r1≤0.4×S0.

10. The electronic component according to claim 1, wherein
T0 is a dimension of the element body in a height direction,
r2 is a distance between the portion of the first curved portion that projects farthest and the second imaginary plane in the height direction, and
0.1×T0≤r2≤0.4×T0.

11. The electronic component according to claim 1, wherein
S0 is a smaller of a dimension of the element body in a first direction orthogonal to the length direction and a dimension of the element body in a second direction orthogonal to the first direction and the length direction,
a distance r3 between the center of the element body and a portion of the second apex portion nearest to the center, and
0.1×S0≤r3≤0.4×S0.

12. The electronic component according to claim 1,
wherein
T0 is a dimension of the element body in a height direction,
r4 is a distance between the portion of the second curved portion that projects farthest and the second imaginary plane in the height direction, and
0.1×T0≤r4≤0.4×T0.

13. The electronic component according to claim 1, wherein
L0 is a total length of the element body,
the first outer electrode has a maximum thickness t1 in the length direction, and 0.0006×L0≤t1≤0.015×L0, and
wherein the second outer electrode has a maximum thickness t2 in the length direction, and 0.0006×L0≤t2≤0.015×L0.

14. The electronic component according to claim 13, wherein a difference between the maximum thickness t1 and the maximum thickness t2 is greater than or equal to 20 μm.

15. The electronic component according to claim 13, wherein the maximum thickness t1 is greater than the maximum thickness t2.

16. An electronic component comprising:
an element body having a length L0 in a length direction, the element body including a first end surface and a second end surface;
a first outer electrode on the first end surface having a maximum thickness t1 in the length direction; and
a second outer electrode on the second end surface having a maximum thickness t2, wherein
0.0006×L0≤t1≤0.015×L0,
0.0006×L0≤t2≤0.015×L0, and
a difference between the maximum thickness t1 and the maximum thickness t2 is greater than or equal to 20 μm.

17. The electronic component according to claim 16, wherein the maximum thickness t1 is greater than the maximum thickness t2.

18. A method of manufacturing an electronic component, the method comprising:
partially immersing an element body in an electroconductive paste layer from a first end surface side; and
withdrawing the element body from the electroconductive paste layer while moving the element body relative to the electroconductive paste layer in a direction from a fourth side surface toward a third side surface and from a second side surface toward a first side surface, thereby forming a first-end protruding portion on a first outer electrode and a first curved portion on a first-side first outer electrode.

19. The method according to claim 18, further comprising tearing the electroconductive paste starting from a portion corresponding to the first-end protruding portion to form a first recessed portion surrounded by the first apex portion.

20. The method according to claim 18, wherein the partial immersion and the withdrawing are repeatedly performed a plurality of times.
